(19) United States
(12) Patent Application Publication
(10) Pub. No.: US 2024/0042525 A1
(43) Pub. Date: Feb. 8, 2024

(54) LASER POWDER BED FUSION ADDITIVE MANUFACTURING METHODS

(71) Applicant: RENISHAW PLC, Wotton-under-Edge, Gloucestershire (GB)

(72) Inventors: Mathieu BROCHU, Montreal (CA); Xianglong WANG, Montreal (CA)

(73) Assignee: RENISHAW PLC, Wotton-under-Edge, Gloucestershire (GB)

(21) Appl. No.: 18/269,914

(22) PCT Filed: Jan. 24, 2022
(86) PCT No.: PCT/GB2022/050175

§ 371 Date: Jun. 27, 2023

(30) Foreign Application Priority Data
Jan. 22, 2021 (GB) 2100843.8

(51) Int. Cl. B22F 10/28; B22F 10/32; B22F 10/362

(52) U.S. Cl. CPC B22F 10/28; B22F 10/32; B22F 10/362; B33Y 10/00

(57) ABSTRACT

A laser powder bed fusion additive manufacturing method including performing laser melting of layers of a powder bed of steel powder in a protective atmosphere including nitrogen, wherein a temperature of the powder bed is below 220° C. A composition of the steel powder may include, by weight: 3% to 7% Cr, 2-5% Mo, 0.2% to 0.7% V, max 0.7% Si, max 1% Mn, max 1.5% C, and a balance of Fe.

### FIELD OF INVENTION

This invention concerns a laser powder bed fusion additive manufacturing method. The invention has particular application to building an object from steel, more particularly a tool steel, and even more preferably a hot tool work steel, such as BOHLER W360 AMPO.

### BACKGROUND

Laser powder bed fusion additive manufacturing comprises layer-by-layer solidification of a powder, such as a metal powder material, using a laser beam. A powder layer is deposited on a powder bed in a build chamber and the laser beam is scanned across portions of the powder layer that correspond to a cross-section of the object being constructed. The laser beam melts the powder to form a solidified layer. After selective solidification of a layer, the powder bed is lowered by a thickness of the newly solidified layer and a further layer of powder is spread over the surface and solidified, as required.

To avoid oxidation of the metal during the build, the build is carried out in a chamber containing a protective atmosphere. Argon is usually used as the gas of the protective atmosphere, although other noble gases or nitrogen may also be used. The chamber is purged of oxygen and filled with a protective gas, reducing an oxygen content in the chamber to less than 0.1%.

A problem with building objects from steels, such as BOHLER W360 AMPO, using laser powder bed fusion additive manufacturing is that the materials are prone to cracking upon solidification. To avoid the formation of cracks, it is known to preheat the powder bed. WO2019/233962 discloses examples of carrying out powder bed fusion additive manufacturing of steel powder in which the powder bed is heated to 230° C., 400° C. and 500° C.

A problem with the preheating of the powder bed to such temperatures is that it requires heating elements within the laser powder bed fusion additive manufacturing machine and the machine must be designed to withstand these temperatures of the powder bed. This increases the complexity of the machine and therefore, increases the cost and reduces the reliability of the machine. Furthermore, a time between finishing the build and removing the object from the machine is increased because the user may have to wait for the powder bed and object to cool before the object is separated from the powder and removed from the machine.

### SUMMARY OF INVENTION

According to a first aspect of invention there is provided a laser powder bed fusion additive manufacturing method comprising performing laser melting of layers of a powder bed of steel powder in a protective atmosphere comprising nitrogen, wherein a (bulk) temperature of the powder bed is below 220° C.

It has been found that by melting the tool steel powder in a protective atmosphere comprising nitrogen a temperature of the powder bed can be reduced without introducing an unacceptable number of cracks. In particular, it is believed absorption of nitrogen into the melt pool retards austenite to martensitic transformations, increasing an amount of residual austenite as a volume fraction in the final solidified material compared to building an object under similar conditions but in an argon atmosphere. The additional soft and compliant austenite may accommodate the high residual stress resulting from the rapid cooling during the laser powder bed fusion process, preventing the hard, yet brittle component from cracking. In this way, the method can be carried out in machines without preheating the powder to temperatures above 230° C.

The method may comprise laser melting of the powder layers of the powder bed, wherein a (bulk) temperature of the powder bed is below 200° C. and preferably below 170° C. The method may comprise laser melting of the powder layers of the powder bed, wherein a temperature of a build platform supporting the powder bed is below 220° C., preferably below 200° C., and most preferably below 170° C. The method may comprise laser melting of the powder layers of the powder bed, wherein a temperature of walls of a build chamber containing the powder bed is below 220° C., preferably below 200° C., and most preferably below 170° C. The method may comprise laser melting of the powder layers of the powder bed, wherein a surface temperature of the powder bed is below 220° C., preferably below 200° C., and most preferably below 170° C.

By carrying out the method at powder bed temperatures below 220° C., and preferably below 200° C., and most preferably below 170° C., it is not necessary to carry out the method in laser powder bed fusion machines capable of heating the powder bed to 230° C. and above. Furthermore, a time between the build finishing and removal of the object from the machine may be reduced due to the lower powder bed temperature.

The method may comprise preheating the powder bed to a (bulk) temperature above 80° C., preferably above 100° C., more preferably above 120° C. and optionally above 150° C. The method may comprise preheating the build platform to a temperature above 80° C., preferably above 100° C., more preferably above 120° C. and optionally above 150° C. The method may comprise preheating walls of the build chamber containing the powder bed to above 80° C., preferably above 100° C., more preferably above 120° C. and most optionally above 150° C. The method may comprise melting of the powder layers of the powder bed, wherein a surface temperature of the powder bed is above 80° C., preferably above 100° C., more preferably above 120° C. and optionally above 150° C. It is believed that preheating of the steel powder may be required to suppress martensite formation during solidification of the molten material, which is believed to reduce solidification cracking, even in the presence of a nitrogen atmosphere, although the preheating temperature will be lower than if the powder was melted under an argon atmosphere. The preheating temperature will be linked to a martensite start temperature for the steel powder under a nitrogen atmosphere, which may in the range of 80° C. to 150° C. depending on the composition of the steel powder and the amount of nitrogen present in the solid solution.

In some embodiments it may be desirable to have a protective atmosphere substantially consisting of nitrogen. In these embodiments nitrogen having a purity of 99.998% may be used and a protective atmosphere having up to 99.998% nitrogen may be achieved, in other embodiments having a protective atmosphere substantially comprising nitrogen protective atmosphere having 99.99% nitrogen, 99.95% nitrogen, 99.9% nitrogen, or 99.8% may be achieved.

Optionally the protective atmosphere may consist essentially of nitrogen and a further protective gas, for example a noble gas such as argon or helium. The protective atmosphere may comprise at least 5% nitrogen by volume, optionally the protective atmosphere may comprise nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally the oxygen concentration in the protective atmosphere may be less than 1000 ppm, optionally less than 500 ppm.

The protective atmosphere may comprise at least 5% argon by volume, optionally at least 10%, optionally at least 20%, optionally at least 30%, optionally at least 40%, optionally at least 50%, optionally at least 60%.

The oxygen concentration in the protective atmosphere may be less than 1000 ppm, optionally less than 900 ppm, optionally less than 800 ppm, optionally less than 700 ppm, optionally less than 600 ppm, optionally less than 500 ppm, optionally less than 400 ppm, optionally less than 300 ppm, optionally less than 200 ppm, optionally less than 100 ppm.

The steel powder may comprise a chromium content of 3-7% by weight. The steel powder may be a Cr—Mo—V steel.

The steel powder may be a tool steel powder. The tool steel powder may be a hot working tool steel powder.

The tool steel powder may be a hot working tool steel powder. The tool steel/hot working steel powder may comprise a chromium content of 5%. The tool steel/hot working steel powder may be a Cr—Mo—V tool steel/hot working steel powder.

The steel may have a carbon content of 0.3 to 0.6% by weight.

The composition of the steel powder may comprise, by weight:

| | |
|---|---|
| Chromium, Cr | 3-7%, preferably 4% to 6%, and more preferably |
| | 4.2% to 5.0% |
| Molybdenum, Mo | 0.5-5%, preferably 2-5%, and even more preferably |
| | 2.8% to 3.3% |
| Silicon, Si | max 1.5%, preferably max 0.7%, and more |
| | preferably 0.05%-0.7%, and |
| | even more preferably 0.1% to 0.3% |
| Vanadium, V | 0.1% to 1.5%, preferably 0.2% to 0.7%, and more |
| | preferably 0.41% to 0.69% |
| Manganese, Mn | max1%, and more preferably 0.1% to 0.4% |
| Carbon, C | max1.5%, and preferably 0.3% to 0.6%, and even |
| | more preferably 0.45% to 0.56% |
| Iron, Fe | Bal |

The composition may comprise no other major components (above 0.5% by weight). Other elements may be present in small amounts (below 0.5% by weight), such as Nickel, Copper, Phosphorus and Sulphur.

The composition of the steel powder may consist essentially of the following, by weight:

| | |
|---|---|
| Chromium, Cr | 3-7%, preferably 4% to 6%, and more preferably |
| | 4.2% to 5.0% |
| Molybdenum, Mo | 0.5-5%, preferably 2-5%, and even more preferably |
| | 2.8% to 3.3% |
| Silicon, Si | max 1.5%, preferably max 0.7%, and more |
| | preferably 0.05%-0.7%, and even |
| | more preferably 0.1% to 0.3% |
| Vanadium, V | 0.1% to 1.5%, preferably 0.2% to 0.7%, and more |
| | preferably 0.41% to 0.69% |
| Manganese, Mn | max1%, and more preferably 0.1% to 0.4% |
| Carbon, C | max1.5%, and preferably 0.3% to 0.6%, and even |
| | more preferably 0.45% to 0.56% |

The balance is Iron, Fe, and impurities resulting from of the manufacturing process.

The steel powder may be BOHLER W360 AMPO.

The steel powder may be H13 tool steel powder.

The steel powder may comprise the following particle size distribution 15-45 μm:

| D10 | 18-24 μm |
|---|---|
| D50 | 29-35 μm |
| D90 | 42-50 μm |
| Apparent density | ≥3.6 (based on ASTM B964 resp. DIN EN ISO |
| | 3923-1) |

Performing laser melting of layers of the powder bed may comprise controlling a laser and/or laser scanner to direct the laser to selected areas of successive ones of the powder layers in accordance with a set of exposure parameters

The exposure parameters may be such that melt pools are formed in transition or conduction mode. It will be understood that “conduction mode” as used herein means that the energy of the energy beam is coupled into the powder bed primarily through heat conduction creating a melt pool having a width equal to or greater than twice its depth (a ratio of depth to width of less than 0.5). This is to be contrasted with keyhole mode in which a hole is formed in the melt pool where material is vaporised by exposure to the energy beam. A melt pool formed in keyhole mode has a deep, narrow profile with a ratio of depth to width of greater than 1.5. A transition mode exists between the conduction mode and the keyhole mode, wherein the energy does not dissipate quickly enough, and the processing temperature rises above the vaporisation temperature. A depth of the melt pool increases, and penetration of the melt pool can start. Preferably, the method comprises exposing the layer to the at least one energy beam to form melt pools in a conduction or transition mode having a depth to width ratio of less than 1.5, preferably, less than 1, more preferably less than 0.75 and most preferably less than or equal to 0.5.

The exposure parameters of the at least one energy beam may be such that a solidification front velocity and/or cooling rate results in a refinement of the microstructure that disrupts a liquid film of molten material formed by irradiating the powder with the at least one energy beam. The exposure parameters of the at least one energy beam may be such that a solidification front velocity and/or cooling rate is above a predetermined threshold. The cooling rate threshold may be above 1.4×10⁶ K/s. The cooling rate may be 1.4×10⁶ K/s to 1.5×10⁷ K/s.

The exposure parameters may include power of the energy beam, scanning velocity of the energy beam, distance (referred to hereinafter as hatch distance) between the scan paths, point distance between points along the scan path and exposure time for each point (and optionally delay time between the point exposures) and/or spot size (or focal distance).

### DESCRIPTION OF THE DRAWINGS

FIG. 1 is a schematic view of a powder bed fusion additive manufacturing apparatus according to an embodiment of the invention;

FIG. 2 is a table of exposure parameters used to build samples of Example 1,

FIG. 3 is a graph of power, point distance and hatch distance for the samples of Example 1 illustrating the samples that had visible cracks and the sample without visible cracks;

FIG. 4 is a table of exposure parameters used to build samples of Example 2;

FIG. 5 is a graph of power, point distance and hatch distance for the samples of Example 2 illustrating the samples that had visible cracks and the samples without visible cracks;

FIG. 6 is a continuous cooling transformation (CCT) diagram for BOHLER W360;

FIG. 7 is an image of sample 9 of Example 2;

FIG. 8 is a magnified image of sample 9 of Example 2;

FIG. 9 is a table of exposure parameters used to build samples of Example 3; and

FIGS. 10a to 10o are magnified images of the samples 1-9 and 11-16, respectively, of Example 3.

### DESCRIPTION OF EMBODIMENTS

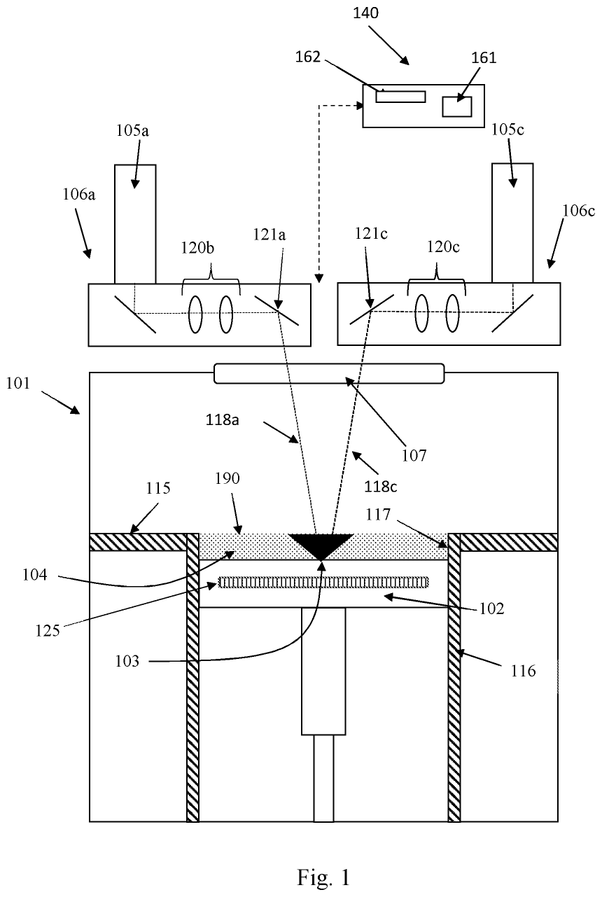

Referring to FIG. 1, a powder bed fusion additive manufacturing apparatus according to an embodiment of the invention comprises a build chamber 101 sealable from the external environment such that a protective atmosphere can be maintained therein. Within the build chamber 101 are partitions 115, 116 that define a build sleeve 117. A build platform 102 is lowerable in the build sleeve 117. The build platform 102 supports a powder bed 104 and workpiece (part) 103 as the workpiece is built by selective laser melting of the powder. The platform 102 is lowered within the build sleeve 117 under the control of a drive (not shown) as successive layers of the workpiece 103 are formed.

Layers of powder 104 are formed as the workpiece 103 is built by a layer formation device, in this embodiment a dispensing apparatus and a wiper (not shown). For example, the dispensing apparatus may be apparatus as described in WO2010/007396. The dispensing apparatus dispenses powder onto an upper surface defined by partition 115 and is spread across the powder bed by the wiper. A position of a lower edge of the wiper defines a working plane 190 at which powder is consolidated. A build direction BD is perpendicular to the working plane 190.

A plurality of laser modules 105a, 105c generate laser beams 118a, 118c, for melting the powder 104, the laser beams 118a, 118c directed as required by a corresponding optical module (scanner) 106a, 106c. The laser beams 118a, 118c, enter through a common laser window 107. In another embodiment, separate windows are provided, typically one for each laser beam, although multiple laser beams may be transmitted through a single window. Each optical module 106a, 106c comprises steering optics 121, such as two mirrors mounted on galvanometers, for steering the laser beam 118 in perpendicular directions across the working plane and focussing optics 120, such as two movable lenses for changing the focus of the corresponding laser beam 118. The scanner is controlled such that the focal position of the laser beam 118 remains in the working plane 190 as the laser beam 118 is moved across the working plane. Rather than maintaining the focal position of the laser beam in a plane using dynamic focusing elements, an f-theta lens may be used.

An inlet and outlet (not shown) are arranged for generating a gas flow across the powder bed formed on the build platform 102. The inlet and outlet are arranged to produce a laminar flow having a flow direction from the inlet to the outlet. Gas is re-circulated from the outlet to the inlet through a gas recirculation loop (not shown).

The apparatus comprises a heater 125 within the build platform 102 for preheating the powder bed 104. Heaters may also be provided in or around the build sleeve or above the powder bed. A temperature sensor (not shown), such as a thermocouple, is provided for measuring a temperature of the build platform 102. The controller 140 controls the heater 125 in response to signals from the temperature sensor. Other temperature sensors may be provided in addition to or as an alternative to this temperature sensor, for example temperature sensors to measure a temperature of the build sleeve 117 and/or the powder bed 104. A temperature sensor may be provided to measure a surface temperature of the powder bed 104.

A controller 140, comprising processor 161 and memory 162, is in communication with modules of the additive manufacturing apparatus, namely the laser modules 105a, 105b, 105c, 105d, optical modules 106a, 106b, 106c, 106d, build platform 102, dispensing apparatus 108 and wiper 109. The controller 140 controls the modules based upon software stored in memory 162 as described below.

In use, a computer receives a geometric model, such as an STL file, describing a three-dimensional object to be built using the powder bed fusion additive manufacturing apparatus. The computer slices the geometric model into a plurality of slices to be built as layers in the powder bed fusion additive manufacturing apparatus based upon a defined layer thickness. In this embodiment, the defined layer thickness, L, is less than 50 micrometres and, preferably 40 micrometres.

The computer may comprise an interface arranged to provide a user input for selecting the material from which the object is to be built. The computer then selects exposure parameters from a database that are suitable for the identified material. A laser exposure pattern is then determined for melting areas of each layer to form the corresponding cross-section (slice) of the object. Based upon these calculations, the computer generates instructions that are sent to controller 140 to cause the additive manufacturing apparatus to carry out a build in accordance with a desired exposure strategy.

A method according to an embodiment of the invention comprises using the apparatus to build an object from BOHLER W360 AMPO steel powder by melting selected areas of successive layers to build the object in a layer-by-layer manner. To build an object/objects, the build chamber 101 is filled with a nitrogen gas to form the protective atmosphere. The heater 125 is activated to heat the build platform 102 to a temperature below 150° C. Melting of the powder with the laser beams is then commenced.

It is believed that the presence of a nitrogen protective atmosphere retards austenite to martensitic transformations during solidification of the material, increasing an amount of residual austenite as a volume fraction in the final solidified object. The additional soft and compliant austenite may accommodate the high residual stress resulting from the rapid cooling during the laser powder bed fusion process, preventing the hard, yet brittle component from cracking.

More particularly, it is believed that the nitrogen in the protective atmosphere dissolves into the molten metal. The nitrogen in the molten solution stabilises the austenite phase and decreases the martensite start temperature (Mₛ). The following equation from L. John, J. K. Damian, Welding metallurgy and weldability of stainless steels, John Wiley & Sons, Inc., Hoboken, New Jersey, 2005 predicts the Mₛ, temperature for steels with a Chromium content within 10 to 18 wt %:—

Mₛ(° F.)=75×(14.6−Cr)+110×(98.9−Ni)+60×(1.33−Mn)+50×(0.47−Si)+3000×(0.068−C−N) (1)

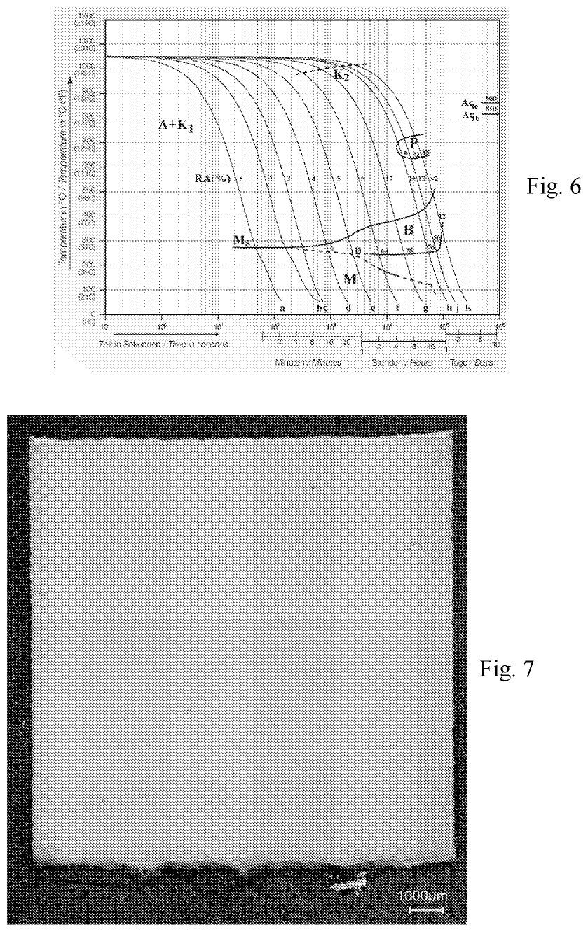

BOHLER W360 AMPO has a Chromium content outside the range for which it is stated that equation (1) applies. However, equation (1) predicts an Mₛ, for W360 of 270° C., which corresponds well to the value in the CCT diagram (see FIG. 6). So, it is believed that equation (1) can be used to give an indication of Mₛ for BOHLER W360 AMPO with nitrogen present in the solid solution. The equation predicts that nitrogen has a similar effect as carbon on Mₛ. Assuming a 0.1 wt % of nitrogen in the solid solution, the steel will experience an approximate 150° C. drop in Mₛ. Hence for such amounts of nitrogen in the solid solution, M s for BOHLER W360 AMPO will be 104° C.

Once the Mₛ, is achieved, the extent of the martensite transformation is only dependent on the amount of undercooling below the Mₛ temperature. Therefore, the volume fraction of martensite (f) in a steel can be estimated as follows:

f=1−exp[−(1.10×10⁻²ΔT)] (2)

where ΔT is the undercooling below Mₛ, in ° C. If we assume that both steels will be cooled to room temperature (22° C.). When zero nitrogen is present in the solid solution, the volume fraction of martensite in W360 will be 0.935. While for a of nitrogen in the solid solution, the volume fraction of martensite in W360 will be 0.594. As a result, with the addition of nitrogen in the solid solution, one can expect a drop in martensite volume fraction, hence lower crack susceptibility.

Even if the nitrogen is excess and is not fully dissolved in the austenite matrix, nitrogen still has a high solubility in both MC and M2C. As a result, the equilibrium carbide volume fraction increases. Meanwhile, the formation of nitride might also increase with increasing nitrogen. These carbides/nitrides can act as additional obstacles impeding dislocation motion that is required for martensite transformation, either via the interaction between the elastic fields of dislocations and precipitates or through Orowan pinning mechanism. This will also retard the formation of martensite and give rise to more retained austenite, thus reducing the crack susceptibility of the steel samples.

Furthermore, it is believed that allowing the object(s) to cool (even after the object(s) has been built) more quickly helps to reduce cracking. Accordingly, the object(s) should be removed from the powder bed to facilitate cooling soon after completion of the build. The lower preheating temperature helps to facilitate the rapid removal of the object(s) from the powder bed. The objects may be removed from the powder bed within 2 hours of the build finishing.

The invention may also be applicable to other steels that experience cold cracking or cracking due to brittleness of martensite for example, H13 tool steel. For such other steels, a martensite start temperature Mₛ may be different to BOHLER W360 AMPO when in the presence of a nitrogen protective atmosphere and, thus the preheating temperature may have to be adjusted to suppress martensite formation (or preheating may not be required at all). Assuming a 0.1 wt % of nitrogen in the solid solution, equation (1) predicts Mₛ for H13 steel of 207° C. Using equation (2), when zero nitrogen is present in the solid solution, the volume fraction of martensite in H13 will be 0.979. While for a 0.1 wt % of nitrogen in the solid solution, the volume fraction of martensite in H13 will be 0.869.

### Example 1

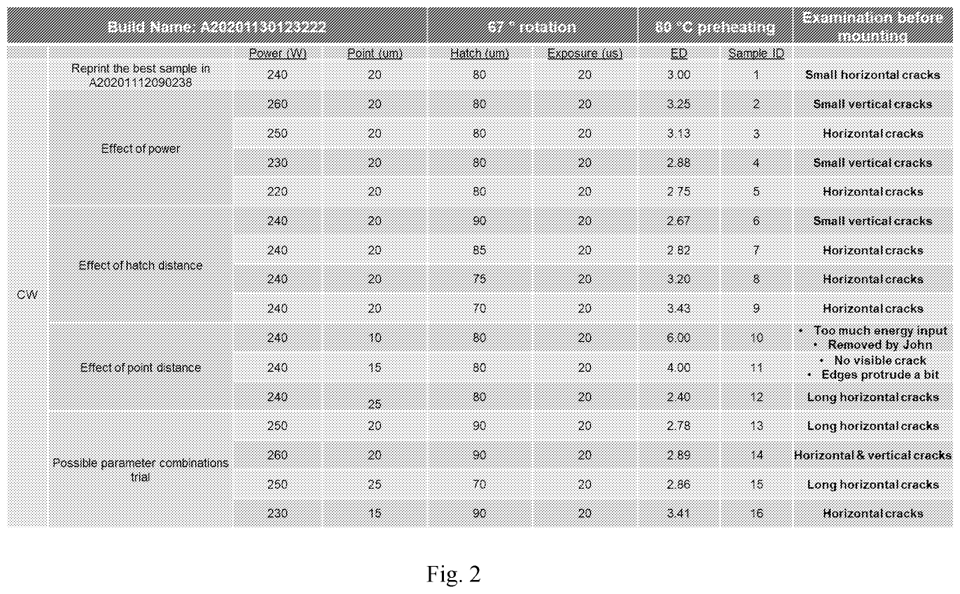

Sixteen 12 mm×12 mm×12 mm cubes were built in a Renishaw RenAM 500 E powder bed fusion apparatus using the exposure parameters set out in FIG. 2 and in a nitrogen protective atmosphere. The cubes were built using a meander scan strategy, which was rotated between layers by 67°. The heater heated the build platform to 80° C.

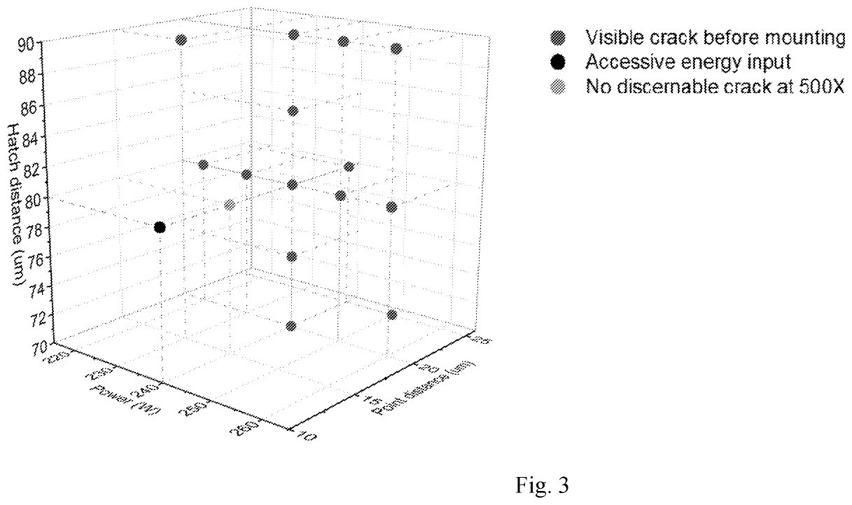

The cubes were examined by eye and the results are shown in the table of FIG. 2. Cracks were visible in all but one of the cubes. FIG. 3 is a graph of power versus hatch distance versus point distance for the set of cubes showing the crack free cubes amongst the cubes having cracks.

### Example 2

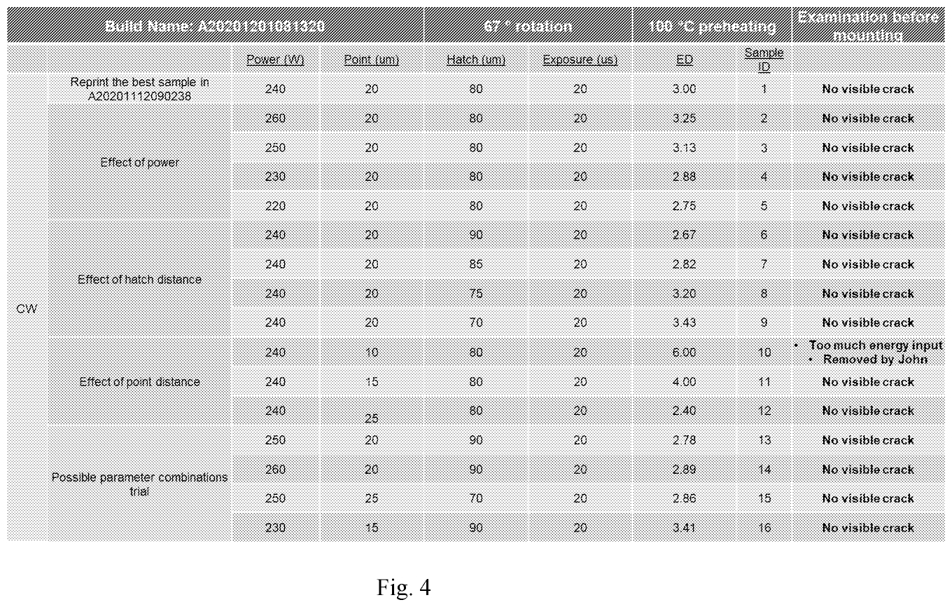

Sixteen 12 mm×12 mm×12 mm cubes were built in a Renishaw RenAM 500 E powder bed fusion apparatus using the exposure parameters set out in FIG. 4 and in a nitrogen protective atmosphere. The cubes were built using a meander scan strategy, which was rotated between layers by 67°. The heater heated the build platform to 100° C.

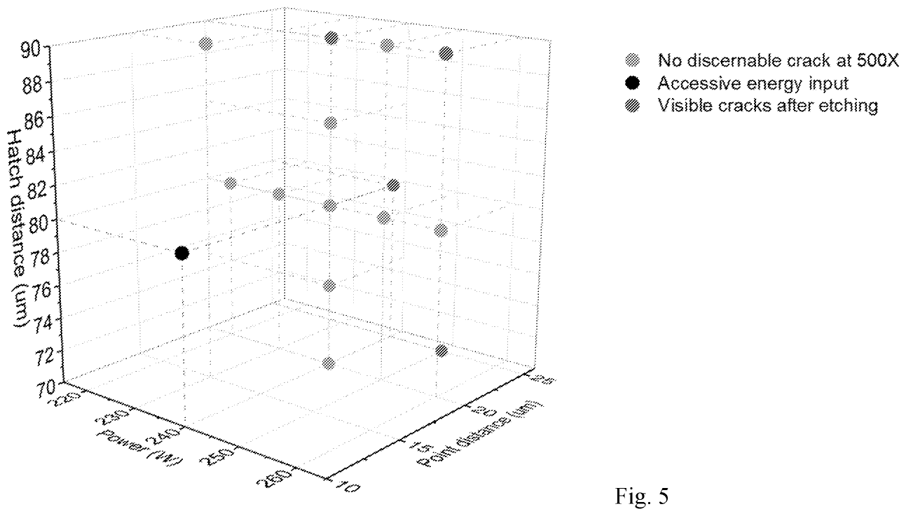

The cubes were examined by eye and by metallographic examination at 400× magnification. The results are shown in the table of FIG. 4. As can be seen no cracks were visible in the cubes by eye. Some of the cubes had cracks visible under magnification. FIG. 5 is a graph of powder versus hatch distance versus point distance for the set of cubes showing the crack free cubes amongst the cubes having cracks.

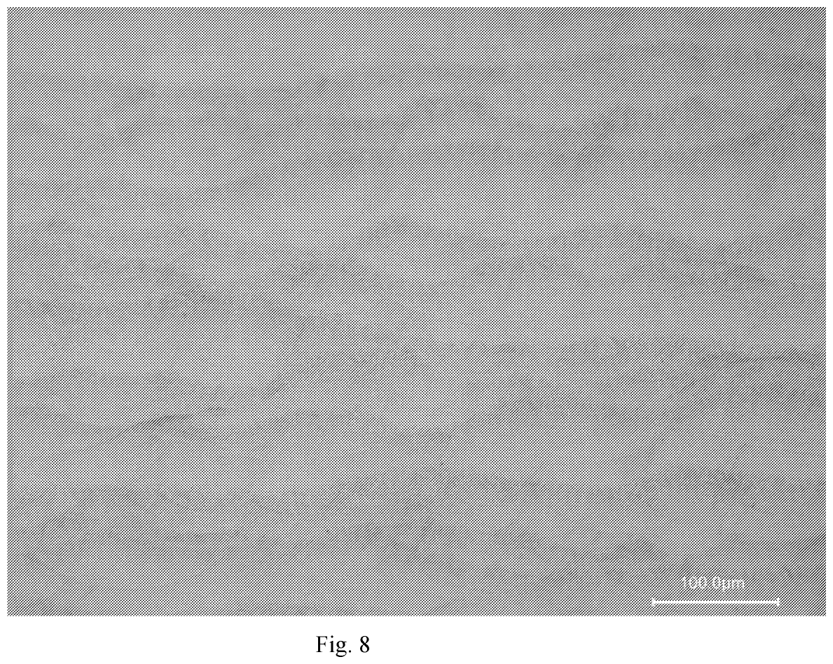

FIG. 7 is an image of sample 9 showing the lack of visible cracks. FIG. 8 is a magnified image of sample 9. The melt pool shape can be seen in the image. The melt pools have a wide, shallow shape corresponding to the formation of melt pools in the conduction or transition mode.

### Example 3

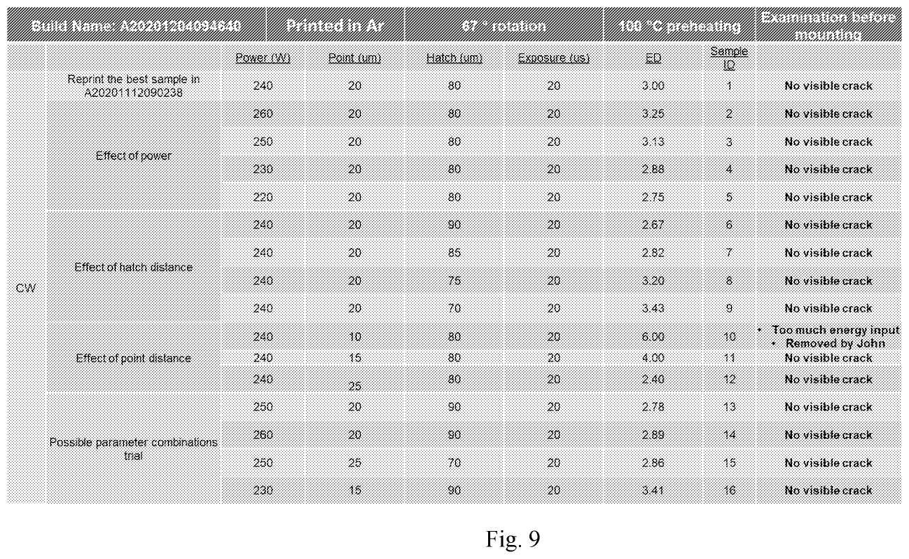

Sixteen 12 mm×12 mm×12 mm cubes were built in a Renishaw RenAM 500 E powder bed fusion apparatus using the exposure parameters set out in FIG. 9 and in an argon protective atmosphere. The cubes were built using a meander scan strategy, which was rotated between layers by 67°. The heater heated the build platform to 100° C.

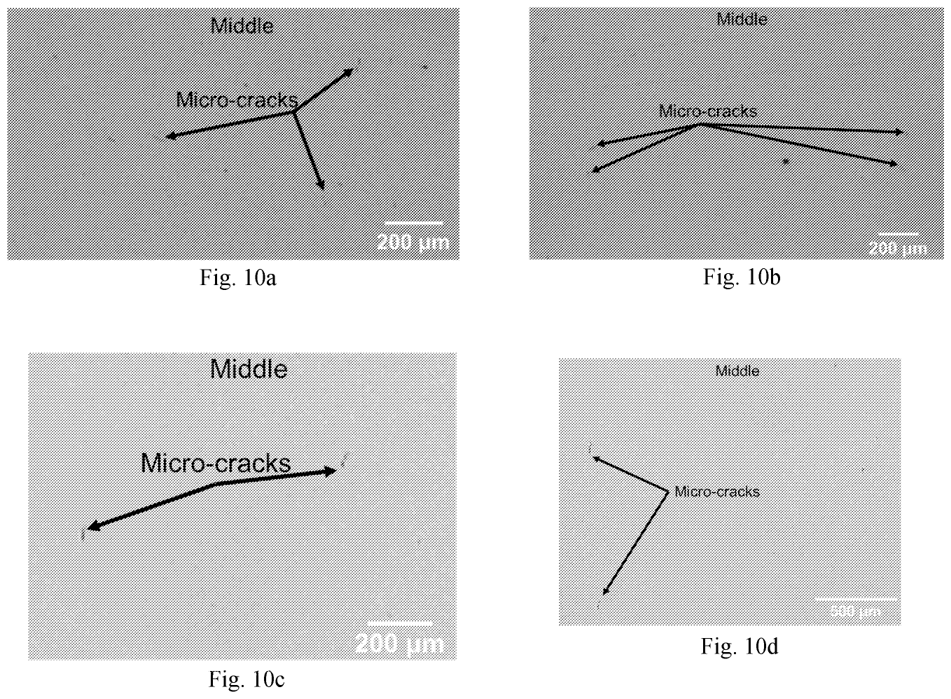

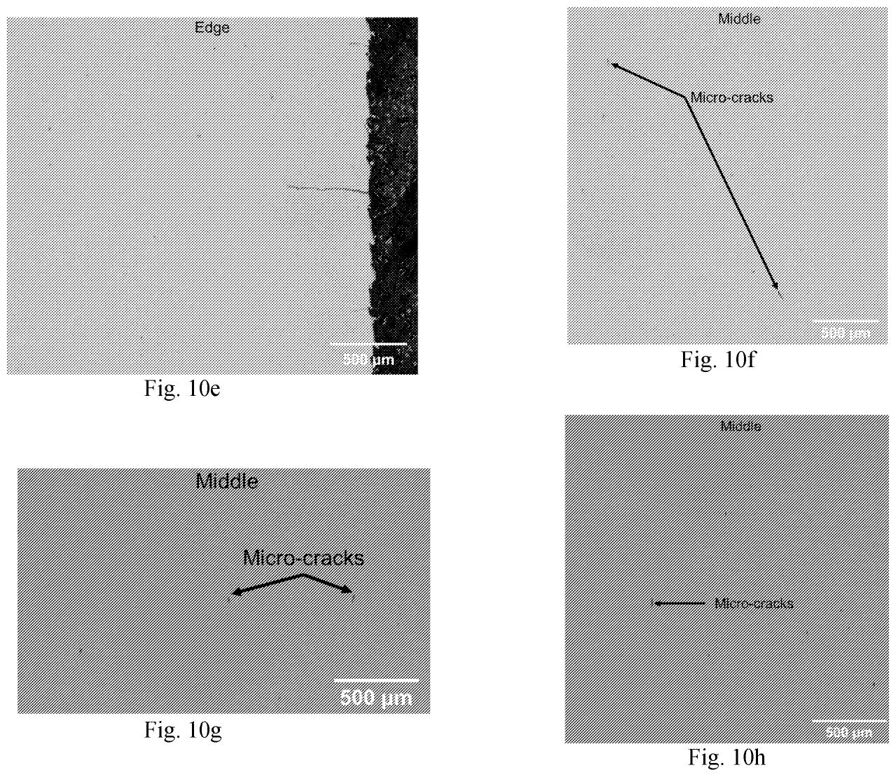

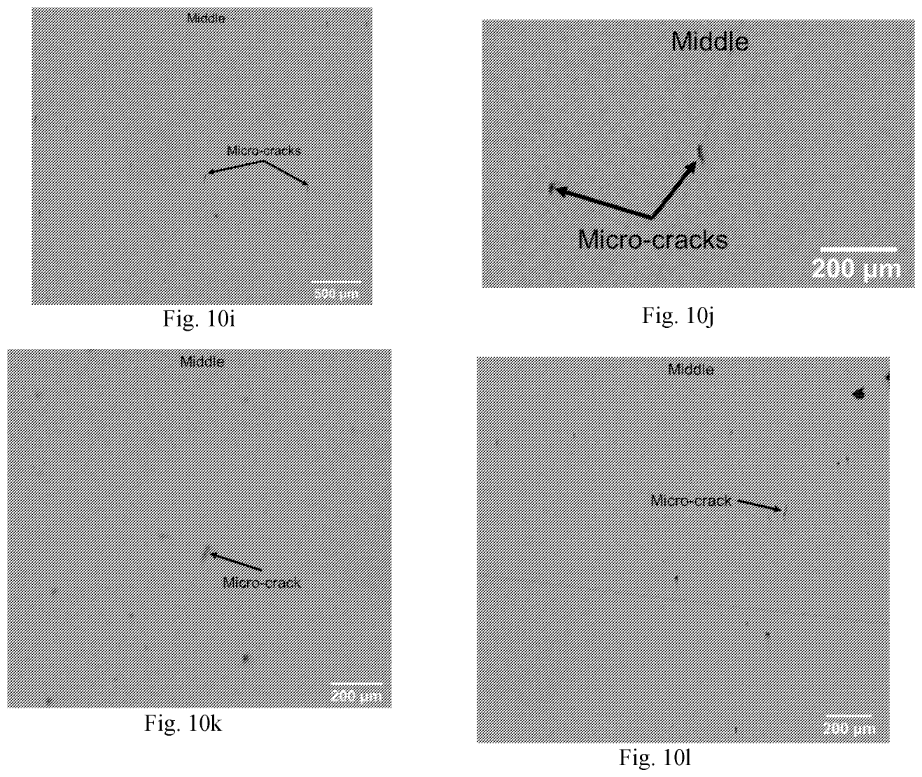

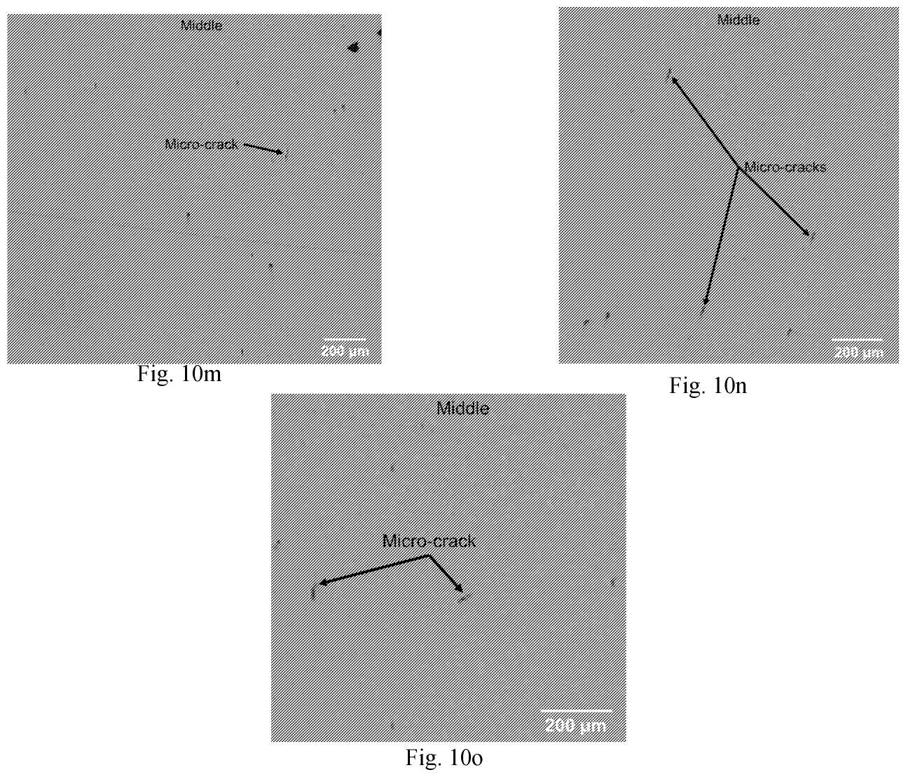

The cubes were examined by eye and by metallographic examination at 400× magnification. Cracks were not visible to the eye but under magnification all the cubes had microcracks. FIGS. 10a to 10o are magnified images of the samples showing the microcracks visible in samples 1-9 and 11-16. There is no image for sample 10 because sample 10 did not build due to the excess energy provided by the parameters of sample 10. These images containing microcracks can be compared to the image shown in FIG. 8, where no microcracks are visible.

1. A laser powder bed fusion additive manufacturing method comprising performing laser melting of layers of a powder bed of steel powder in a protective atmosphere comprising nitrogen, wherein a temperature of the powder bed is below 220° C., and a composition of the steel powder comprises, by weight:
3% to 7% Cr,
2-5% Mo,
0.2% to 0.7% V,
max 0.7% Si,
max 1% Mn,
max 1.5% C, and
balance is Fe.

2. A laser powder bed fusion additive manufacturing method according to claim 1, wherein a temperature of the powder bed is below 170° C.

3. A laser powder bed fusion additive manufacturing method according to claim 1, comprising preheating the powder bed to a temperature above 80° C.

4. A laser powder bed fusion additive manufacturing method according to claim 1, comprising preheating the powder bed to a temperature above 100° C.

5. A laser powder bed fusion additive manufacturing method according to claim 1, comprising preheating the powder bed to a temperature above 120° C.

6. A laser powder bed fusion additive manufacturing method according to claim 1, comprising preheating the powder bed to a temperature above 150° C.

7. A laser powder bed fusion additive manufacturing method according to claim 1, wherein the protective atmosphere consists essentially of nitrogen.

8. A laser powder bed fusion additive manufacturing method according to claim 1, wherein the protective atmosphere consists essentially of nitrogen and a further protective gas.

9. A laser powder bed fusion additive manufacturing method according to claim 8, wherein the further protective gas is a noble gas.

10. A laser powder bed fusion additive manufacturing method according to claim 9, wherein the further protective gas is argon.

11. A laser powder bed fusion additive manufacturing method according to claim 1, wherein an oxygen concentration in the protective atmosphere is less than 1000 ppm.

12. A laser powder bed fusion additive manufacturing method according to claim 1, wherein performing laser melting of layers of the powder bed comprises controlling a laser and/or a laser scanner to direct the laser to selected areas of successive ones of the powder layers in accordance with a set of exposure parameters, wherein the exposure parameters are such that melt pools are formed in transition or conduction mode.
